(19) United States
(12) Patent Application Publication
(10) Pub. No.: US 2011/0032161 A1
(43) Pub. Date: Feb. 10, 2011

(54) MOBILE TERMINAL DEVICE

(75) Inventors: Hideo Nakanishi, Kanagawa (JP); Takeshi Yamaguchi, Kanagawa (JP); Kenji Takagi, Miyagi (JP); Tsukasa Takahashi, Kanagawa (JP); Yuichi Kashino, Miyagi (JP)

Correspondence Address: Seed Intellectual Property Law Group PLLC, 701 Fifth Avenue, Suite 5400, Seattle, WA, 98104, US

(73) Assignee: PANASONIC CORPORATION, Osaka (JP)

(21) Appl. No.: 12/937,934

(22) PCT Filed: Dec. 25, 2008
(86) PCT No.: PCT/JP2008/003979

§ 371 Date: Oct. 14, 2010

(30) Foreign Application Priority Data
Apr. 16, 2008 (JP) 2008-106876

(51) Int. Cl. H01Q 1/24

(52) U.S. Cl. 343/702

(57) ABSTRACT

In a mobile terminal device, a hinge member and a conductive member provided on a chassis and functioning as an antenna are electrically contacted with each other through the slide operation of a chassis and thereby can be configured as an antenna usable in various use situations without providing a separate antenna. Consequently, the mobile terminal device is provided, the manufacture cost of which can be suppressed, the size and thickness of which can be reduced, and which can prevent antenna characteristics from degrading because the antenna is not provided at a portion gripped by a hand. In the device, a first chassis (101) has a radio circuit (112). A second chassis (102) has a ground plate (121) and is attached so as to be freely slidable with respect to the first chassis (101). A tilt hinge member (104a) rotatably connects the first chassis (101) to the second chassis (102), is fed from the radio circuit (112), and functions as an antenna together with the ground plate (121) when the hinge member is electrically contacted with the ground plate (121) through the slide operation of the second chassis (102).

### TECHNICAL FIELD

The present invention relates to a mobile terminal apparatus that can be used to view, for example, digital television broadcast.

### BACKGROUND ART

Conventionally, mobile terminal apparatuses are known that use a hinge part to foldably connect an upper housing which has a metal frame as an antenna element, and a lower housing which has a circuit substrate in which a ground pattern and a power feeding section are provided (for example, Patent Document 1). According to Patent Document 1, the power feeding section of the mobile terminal apparatus feeds power to the metal frame as an antenna element through the hinge part which mechanically supports the upper housing and the lower housing. By this means, according to Patent Document 1, the metal frame of the upper housing, the hinge part and the ground pattern of the circuit substrate of the lower housing operate as a dipole antenna.

Patent Document 1:Japanese Patent Application Laid-Open No. 2005-6096

### DISCLOSURE OF INVENTION

### Problems to be Solved by the Invention

However, in a state where the upper housing and the lower housing are folded in the conventional mobile terminal apparatuses, the metal frame of the upper housing, the hinge part and the ground pattern of the circuit substrate of the lower housing are electrically connected, and the metal frame of the upper housing and the ground pattern of the circuit substrate of the lower housing closely face each other. By this means, the current flowing in the metal frame of the upper housing and the current flowing in the ground pattern of the circuit substrate of the lower housing cancel each other, and therefore there is a problem that the metal frame and the ground pattern cannot be used as an antenna. Further, with the conventional mobile terminal apparatuses, in a state where the upper housing and the lower housing are folded, the dipole antenna formed with the metal frame of the housing, the hinge part and the ground pattern of the circuit substrate of the lower housing does not function as an antenna, and therefore it is necessary to provide a separate antenna that can be used in the folded state. As a result, with the conventional mobile terminal apparatuses, the number of parts increases, thereby increasing the manufacturing cost and making it impossible to make an apparatus smaller and thinner.

It is therefore an object of the present invention to provide a mobile terminal apparatus that can provide an antenna configuration that can be used in various modes of use without providing a separate antenna, by making hinge members which function as an antenna and an electrically conductive member which is provided in the housing electrically contact each other when a housing slides, and, consequently, reduce the manufacturing cost and make the mobile terminal apparatus smaller and thinner, and that can prevent deterioration of antenna characteristics because an antenna is not provided in the portion that is held by the hand.

### MEANS FOR SOLVING THE PROBLEM

The mobile terminal apparatus according to the present invention employs a configuration which includes: a first housing that has a power feeding section; a second housing that has an electrically conductive member and that is attached to be slidable with respect to the first housing; and a hinge member that couples the first housing and the second housing rotatably, and the hinge member is fed power from the power feeding section, and functions as an antenna together with the electrically conductive member when the hinge member electrically contacts the electrically conductive member accompanying the sliding.

### ADVANTAGEOUS EFFECTS OF INVENTION

According to the present invention, it is possible to provide an antenna configuration that can be used in various modes of use without providing a separate antenna, by making hinge members which function as an antenna and an electrically conductive member which is provided in the housing electrically contact each other when a housing slides, and, consequently, reduce the manufacturing cost and make the mobile terminal apparatus smaller and thinner, and prevent deterioration of antenna characteristics because an antenna is not provided in the portion that is held by the hand.

### BRIEF DESCRIPTION OF DRAWINGS

FIG. 1 is a side view of a mobile terminal apparatus according to Embodiment 1 of the present invention;

FIG. 2 is a side view of a mobile terminal apparatus according to Embodiment 1 of the present invention;

FIG. 3 is a side view of a mobile terminal apparatus according to Embodiment 1 of the present invention;

FIG. 4 is a plan view of a mobile terminal apparatus according to Embodiment 1 of the present invention;

FIG. 5 is a front view of a mobile terminal apparatus according to Embodiment 1 of the present invention;

FIG. 6 is a plan view of a mobile terminal apparatus according to Embodiment 1 of the present invention;

FIG. 7 is a perspective view of an auxiliary member according to Embodiment 1 of the present invention;

FIG. 8 shows a flow of current according to Embodiment 1 of the present invention;

FIG. 9 is a side view of a mobile terminal apparatus according to Embodiment 2 of the present invention;

FIG. 10 is a side view of a mobile terminal apparatus according to Embodiment 2 of the present invention;

FIG. 11 is a side view of a mobile terminal apparatus according to Embodiment 2 of the present invention;

FIG. 12 is a plan view of a mobile terminal apparatus according to Embodiment 2 of the present invention;

FIG. 13 is a front view of a mobile terminal apparatus according to Embodiment 2 of the present invention;

FIG. 14 is a plan view of a mobile terminal apparatus according to Embodiment 2 of the present invention;

FIG. 15 shows a flow of current according to Embodiment 2 of the present invention;

FIG. 16 is a plan view of a mobile terminal apparatus according to Embodiment 3 of the present invention;

FIG. 17 is a front view of a mobile terminal apparatus according to Embodiment 3 of the present invention;

FIG. 18 is a plan view of a mobile terminal apparatus according to Embodiment 3 of the present invention; and

FIG. 19 is a side view of a mobile terminal apparatus according to Embodiment 4 of the present invention.

### BEST MODE FOR CARRYING OUT THE INVENTION

Hereinafter, embodiments of the present invention will be explained in detail with reference to the accompanying drawings.

### Embodiment 1

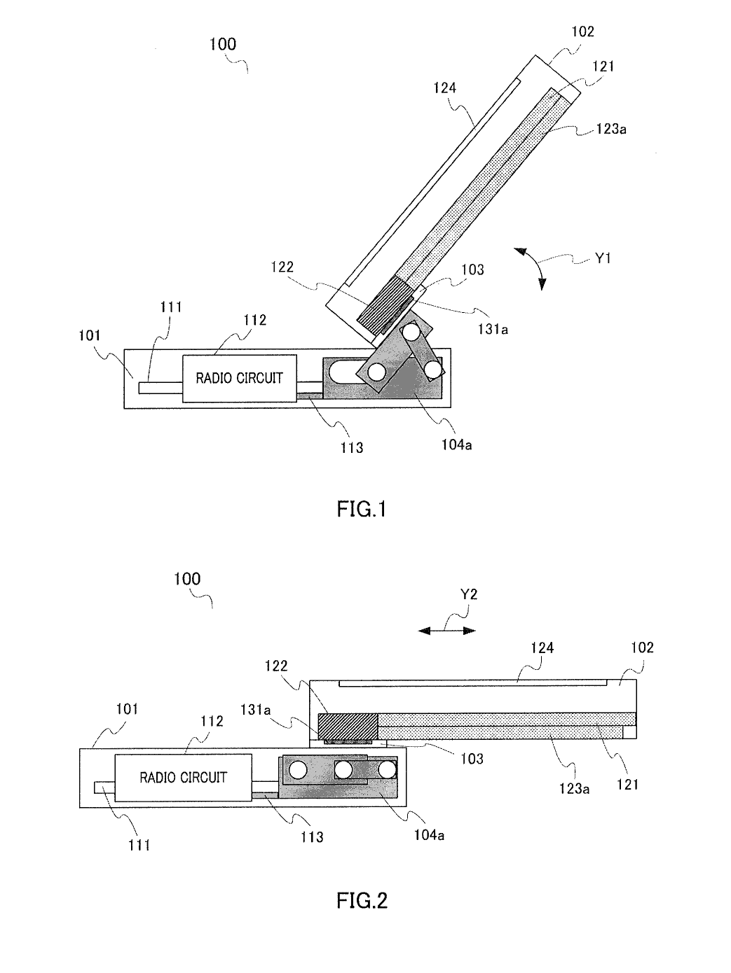

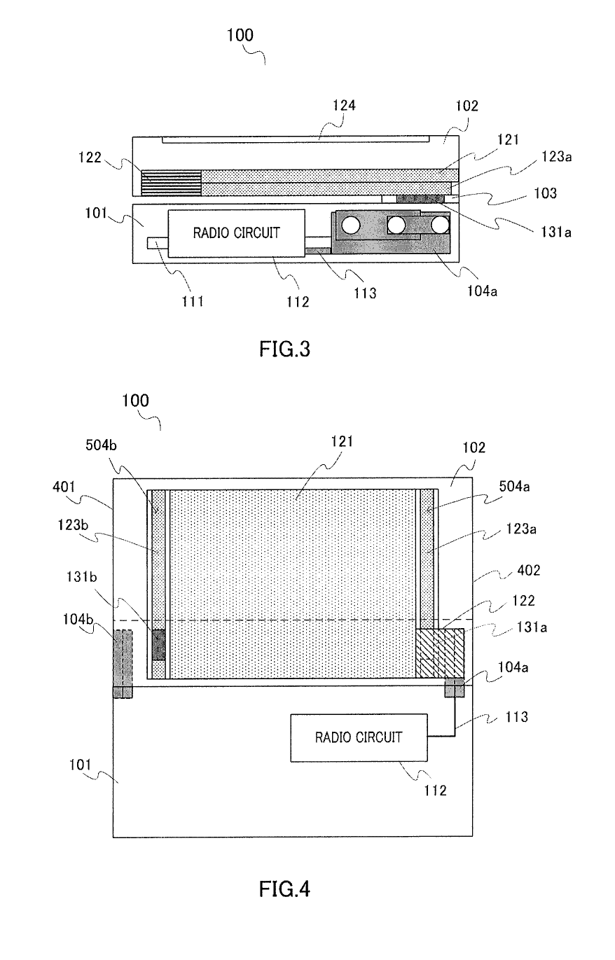

FIG. 1 to FIG. 3 are side views of mobile terminal apparatus 100 according to Embodiment 1 of the present invention. FIG. 1 shows the open state of mobile terminal apparatus 100, FIG. 2 shows the intermediate state between the open state and the closed state of mobile terminal apparatus 100 and FIG. 3 shows the closed state of mobile terminal apparatus 100.

Mobile terminal apparatus 100 is formed mainly with first housing 101, second housing 102, auxiliary member 103 and tilt hinge members 104a and 104b (tilt hinge member 104b is not shown in FIG. 1 to FIG. 3).

First housing 101 is provided with tilt hinge members 104a and 104b.

Second housing 102 can be placed in a state where second housing 102 rises at a predetermined angle with respect to first housing 101 (i.e. the state shown in FIG. 1, hereinafter “open state”), a state where second housing 102 slides with respect to first housing 101 overlapping part of first housing 101 (i.e. the state shown in FIG. 2, hereinafter “sliding state”) or a state where second housing 102 overlaps first housing 101 (i.e. the state shown in FIG. 3, hereinafter “closed state”). In the closed state, second housing 102 is attached to be slidable in the right direction in FIG. 3 with respect to first housing 101. Further, in the sliding state, second housing 102 is attached to be slidable in the left direction in FIG. 2 with respect to first housing 101. That is, second housing 102 is attached to be slidable in the left and right directions in FIG. 1 to FIG. 3 (i.e. arrow direction Y2 in FIG. 2) with respect to first housing 101. Further, in the open state, second housing 102 is supported by tilt hinge parts 104a and 104b and held in a state where second housing 102 rises at a predetermined angle with respect to first housing 101.

Auxiliary member 103 is attached to first housing 101 such that auxiliary member 103 can rotate in arrow direction Y1 pivotally around one end. When auxiliary member 103 is placed in the open state from the sliding state, or in the sliding state from the open state, auxiliary member 103 and second housing 102 rotate in arrow direction Y1 together. Further, auxiliary member 103 has sliders 131a and 131b (slider 131b is not shown in FIG. 1 to FIG. 3) which are guided by guide rails 123a and 123b (guide rail 123b is not shown in FIG. 1 to FIG. 3) which will be described later.

Tilt hinge members 104a and 104b are provided in first housing 101, and couple first housing 101 and second housing 102 rotatably when second housing 102 rotates in arrow direction Y1. Further, in the open state and sliding state, tilt hinge member 104a is fed power from radio circuit 112, capacitive-couples with extending element 122 and electrically contact extending element 122 to electrically contact ground plate 121. By this means, tilt hinge part 104a and ground plate 121 function as an antenna together. On the other hand, in the closed state, tilt hinge member 104a is placed in electrically non-contact with extending element 122, and thereby is placed in electrically non-contact with ground plate 121. In this case, as shown in FIG. 3, tilt hinge member 104a is fed power from radio circuit 112, and functions alone as an antenna because it is spaced apart from extending element 122 and ground plate 121 a distance tilt hinge member 104a cannot electrically connect with them. Note that ground plate 121 may be formed with a circuit substrate having a ground layer.

Next, first housing 101 will be explained in more details.

First housing 101 has circuit substrate 111, radio circuit 112 and electrically conductive connecting part 113.

Radio circuit 112 is mounted on circuit substrate 111. Further, circuit substrate 111 has an electrically conductive circuit pattern printed in the top surface and the back surface.

Radio circuit 112 is mounted on circuit substrate 111, electrically connects with the circuit pattern formed in circuit substrate 111 and applies radio processing to signals received at the antenna. Further, radio circuit 112 functions as a power feeding section which feeds power to tilt hinge members 104 through electrically conductive connecting part 113.

Electrically conductive connecting part 113 electrically connects radio circuit 112 and tilt hinge members 104. Electrically conductive connecting part 113 may be formed with a member different from circuit substrate 111, or may be formed on circuit substrate 111 as a circuit pattern.

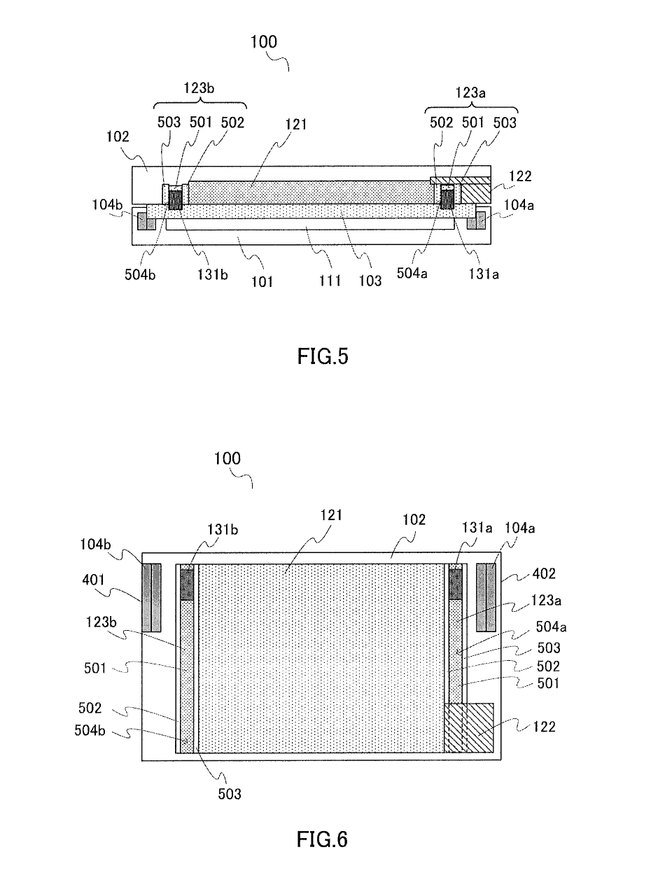

Next, second housing 102 will be explained in more details using FIG. 4 to FIG. 6 in addition to FIG. 1 to FIG. 3. FIG. 4 and FIG. 6 are plan views of mobile terminal apparatus 100, and FIG. 5 is a front view of mobile terminal apparatus 100. Here, FIG. 4 shows the open state of mobile terminal apparatus 100, and FIG. 6 shows the closed state of mobile terminal apparatus 100. Note that, in FIG. 4 to FIG. 6, tilt hinge members 104a and 104b, radio circuit 112 and electrically conductive connecting part 113 are provided in first housing 101, sliders 131a and 131b are provided in auxiliary member 103 and the other members are provided in second housing 102. Further, FIG. 4 and FIG. 6 do not show auxiliary member 103 for ease of explanation.

Second housing 102 is rectangular from a plan view, and has ground plate 121, extending element 122, guide rail 123 and display section 124.

Ground plate 121 as an electrically conductive member is grounded, is flat and is arranged in virtually the entire surface inside second housing 102.

Extending element 122 electrically connects ground plate 121 and tilt hinge member 104a across guide rail 123a. In this case, extending element 122 electrically contacts tilt hinge member 104a by capacitive-coupling. Note that extending element 122 may electrically connect ground plate 121 and tilt hinge member 104b instead of electrically connecting ground plate 121 and tilt hinge member 104a. Further, extending element 122 may not only capacitive-couple with tilt hinge member 104a, but also mechanically connect with and electrically contact tilt hinge member 104a.

As shown in FIG. 5, guide rails 123a and 123b have groove parts 504a and 504b formed by bottom surface parts 501 and side surface parts 502 and 503. Further, guide rails 123a and 123b are provided in both end parts in the longitudinal direction (i.e. the left and right directions in FIG. 4) of rectangular second housing 102 from a plan view. Further, in second housing 102, guide rails 123a and 123b are provided along short sides 401 and 402 of rectangular second housing 102 from a plan view and in parallel to the lateral direction (i.e. the up and down directions in FIG. 4) of rectangular second housing 102 from a plan view. Groove parts 504a and 504b engage slidably with sliders 131a and 131b of auxiliary member 103. By this means, second housing 102 is allowed to slide in the lateral direction of rectangular second housing 102 from a plan view.

Display section 124 is, for example, an LCD, and displays an image of image data received at the antenna formed with electrically conductive connecting part 113, tilt hinge members 104 and ground plate 121.

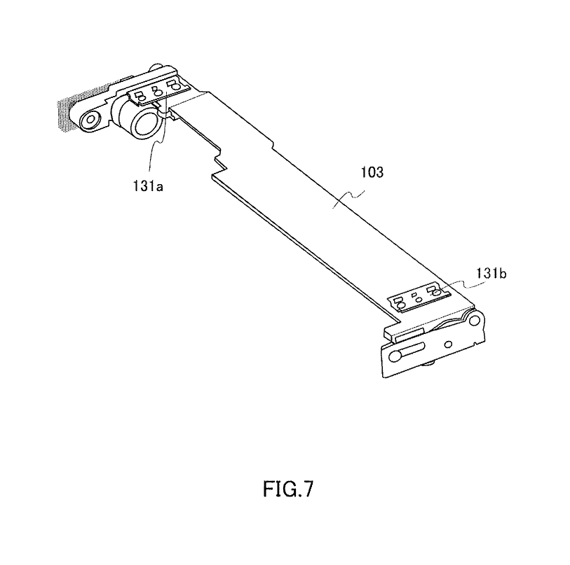

FIG. 7 is a perspective view of auxiliary member 103.

Auxiliary member 103 has slider 131a which engages slidably with groove part 504a of guide rail 123a, and slider 131b which engages slidably with groove part 504b of guide rail 123b.

Next, the operation of mobile terminal apparatus 100 will be explained using FIG. 1 to FIG. 6.

In the closed state of mobile terminal apparatus 100, second housing 102 is slid in the right direction in FIG. 3 with respect to first housing 101. In this case, sliders 131a and 131b are guided by guide rails 123a and 123b, so that second housing 102 slides with respect to first housing 101. In this way, mobile terminal apparatus 100 is placed in the sliding state from the closed state.

Further, mobile terminal apparatus 100 is placed in the sliding state from the closed state, so that extending element 122 and second housing 102 slide together, placing extending element 122 and tilt hinge member 104a in the electrically contacting state from the electrically non-contacting state and placing ground plate 121 and tilt hinge member 104a in the electrically contacting state from the electrically non-contacting state.

By this means, mobile terminal apparatus 100 is placed in a state where tilt hinge members 104 and ground plate 121 function as an antenna, from the state where tilt hinge members 104 function alone as an antenna.

Next, in the sliding state of mobile terminal apparatus 100, second housing 102 is tilted up with respect to first housing 101. That is, in a state where second housing 102 couples with first housing 101 through tilt hinge members 104a and 104b, second housing 102 rotates in a direction to rise with respect to first housing 101, and is held in a state where second housing 102 rises at a predetermined angle by tilt hinge members 104a and 104b. By this means, mobile terminal apparatus 100 is placed in the open state.

In the open state, mobile terminal apparatus 100 maintains the state where ground plate 121 and tilt hinge member 104a electrically contact, so that tilt hinge members 104 and ground plate 121 function as an antenna. Thus, the antenna formed with tilt hinge members 104 and ground plate 121 receives radio waves of, for example, digital television broadcast, and display images of, for example, digital television broadcast on display section 124 provided in second housing 102.

To view, for example, digital television broadcast, in the open state of mobile terminal apparatus 100, second housing 102 rotates in the direction in which second housing 102 lies with respect to first housing 101 in the state where second housing 102 couples with first housing 101 through tilt hinge members 104. By this means, mobile terminal apparaus 100 is placed in the sliding state.

Next, second housing 102 slides with respect to first housing 101 in a direction in which second housing 102 overlaps first housing 101. By this means, mobile terminal apparatus 100 is placed in the closed state.

Further, mobile terminal apparatus 100 is placed in the closed state from the sliding state, so that extending element 122 and second housing 102 slide together. By this means, extending element 122 slides in a direction to part from tilt hinge member 104a, such that extending element 122 and tilt hinge member 104a are placed in the electrically non-contacting state from the electrically contacting state, and ground plate 121 and tilt hinge member 104a are placed in the electrically non-contacting state from the electrically contacting state.

By this means, mobile terminal apparatus 100 is placed in the state where tilt hinge member 104a functions alone as an antenna, from the state where tilt hinge member 104a and ground plate 121 function as an antenna.

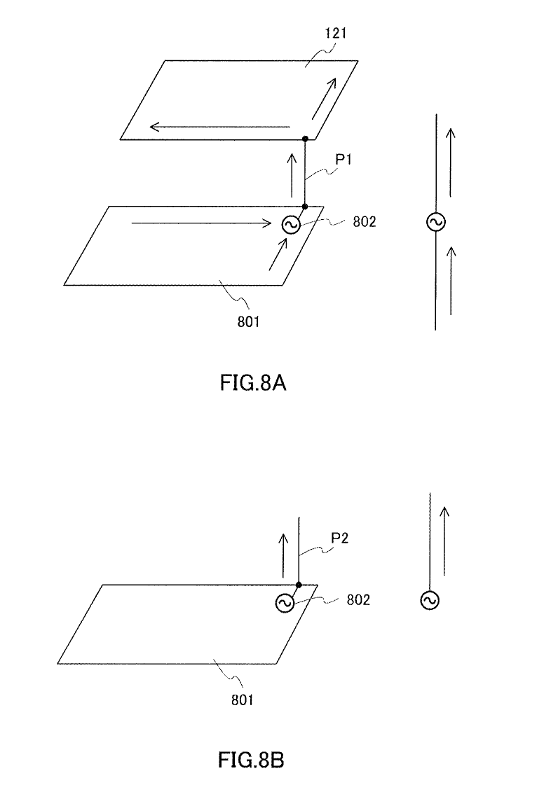

FIG. 8 shows a flow of current. FIG. 8A shows a flow of current in the sliding state and in the open state, and FIG. 8B shows a flow of current in the closed state.

In the open state and the sliding state, ground part 801, power feeding section 802, electrically conductive path P1 and ground plate 121 provided in circuit substrate 111 function as an antenna, so that the flow of current becomes as shown in FIG. 8A, and they function as a dipole antenna. Here, electrically conductive path P1 is formed with electrically conductive connecting part 113, tilt hinge member 104a and extending element 122.

On the other hand, in the closed state, power feeding section 802 and electrically conductive path P2 function as an antenna, so that the flow of current becomes as shown in FIG. 8B, and they function as a monopole antenna. Here, electrically conductive path P2 is formed with electrically conductive part 113 and tilt hinge member 104a.

Thus, according to the present embodiment, it is possible to provide an antenna configuration that can be used in various modes of use without providing a separate antenna, by making hinge members which function as an antenna and an electrically conductive member which is provided in the housing electrically contact each other when a housing slides, and, consequently, reduce the manufacturing cost and make the mobile terminal apparatus smaller and thinner. Further, according to the present embodiment, it is possible to prevent deterioration of antenna characteristics because an antenna is not provided in the portion that is held by the hand.

Note that, although tilt hinge members and a ground plate electrically contact through an extending element with the present embodiment, the present invention is not limited to this, and the extending element may be formed integrally with the ground plate.

### Embodiment 2

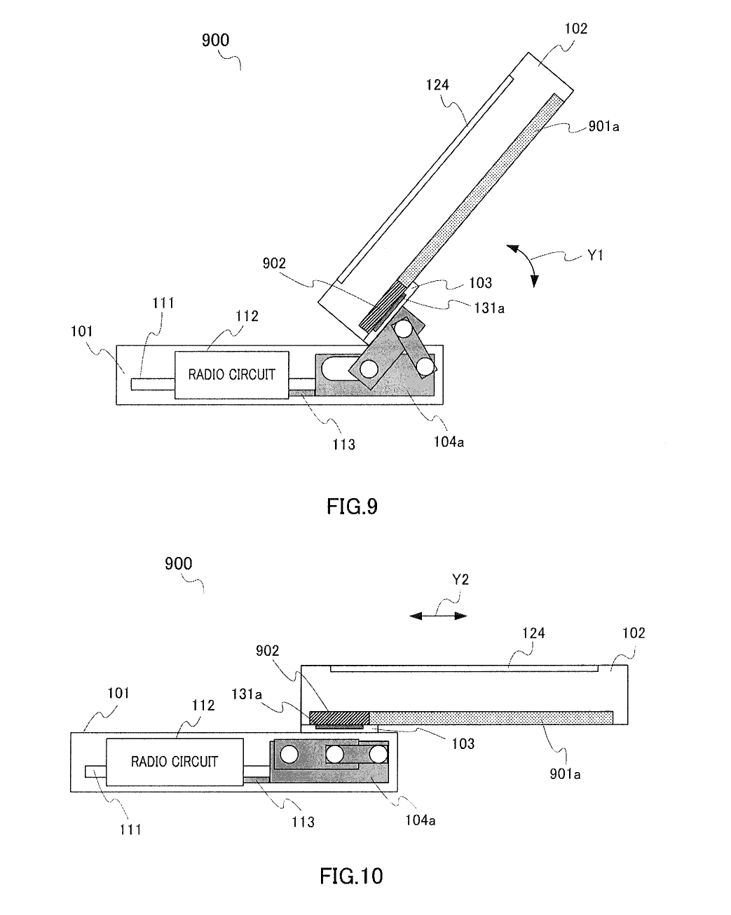

FIG. 9 to FIG. 11 are side views of mobile terminal apparatus 900 according to Embodiment 2 of the present invention.

Compared to mobile terminal apparatus 100 according to Embodiment 1 shown in FIG. 1 to FIG. 3, mobile terminal apparatus 900 shown in FIG. 9 to FIG. 11 removes ground plate 121, and has guide rails 901a and 901b (guide rail 901b is not shown in FIG. 9 to FIG. 11) instead of guide rails 123a and 123b and has extending element 902 instead of extending element 122. Note that, in FIG. 9 to FIG. 11, the same components as in FIG. 1 to FIG. 3 will be assigned the same reference numerals and will not be explained.

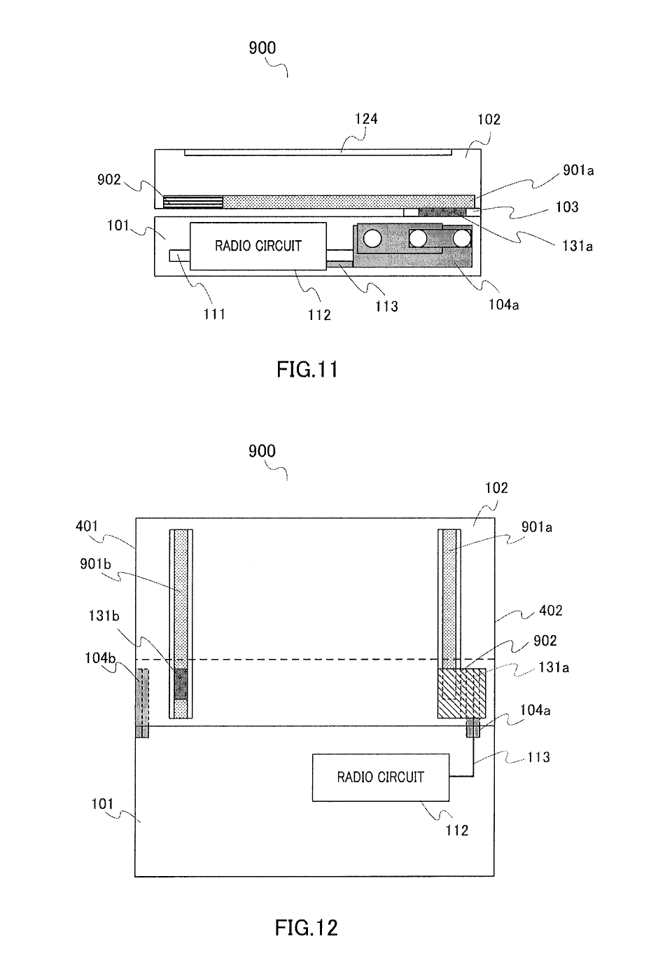

Second housing 102 may be placed in the open state, sliding state or closed state. In the closed state, second housing 102 is attached to be slidable in the right direction in FIG. 11 with respect to first housing 101. Further, in the sliding state, second housing 102 is attached to be slidable in the left direction in FIG. 10 with respect to first housing 101. That is, second housing 102 is attached to be slidable in the left and right directions in FIG. 9 to FIG. 11 (i.e. arrow direction Y2 in FIG. 10) with respect to first housing 101. Further, in the open state, second housing 102 is supported by tilt hinge parts 104a and 104b (tilt hinge member 104b is not shown in FIG. 9 to FIG. 11), and held in a state where second housing 102 rises at a predetermined angle with respect to first housing 101.

Tilt hinge members 104a and 104b are provided in first housing 101, and couple first housing 101 and second housing 102 rotatably when second housing 102 rotates in arrow direction Y1. Further, in the open state and sliding state, tilt hinge member 104a is fed power from radio circuit 112, capacitive-couples with extending element 122 and electrically contacts extending element 122 to electrically contact guide rail 901a as an electrically conductive member (described later). By this means, tilt hinge part 104a and guide rail 901a function as an antenna together. On the other hand, in the closed state, tilt hinge member 104a is placed in electrically non-contact with extending element 902, and thereby is placed in electrically non-contact with guide rail 901a. In this case, as shown in FIG. 11, tilt hinge member 104a is fed power from radio circuit 112, and functions alone as an antenna because it is spaced apart from extending element 902 and guide rail 901a the distance tilt hinge member 104a cannot electrically connect with them.

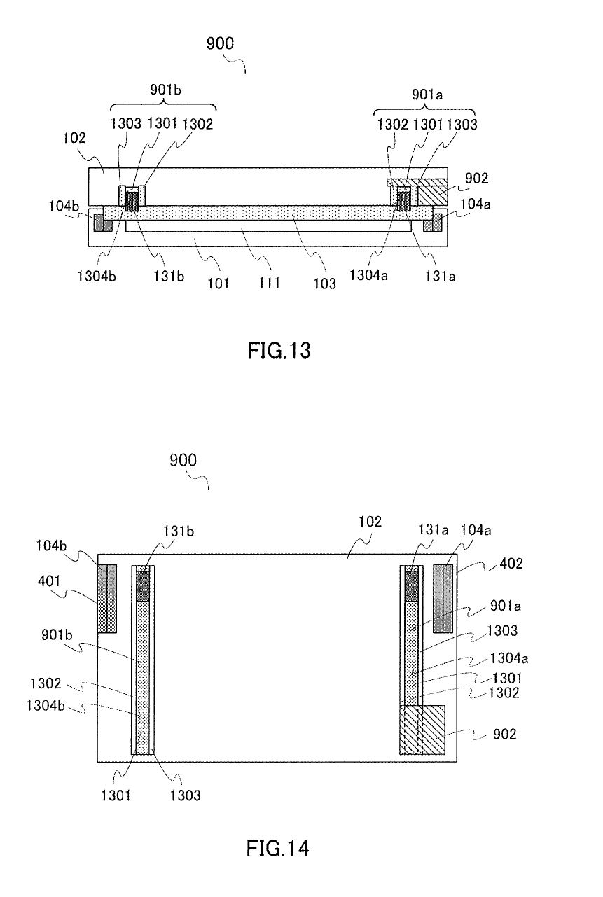

Next, second housing 102 will be explained in more details using FIG. 12 to FIG. 14 in addition to FIG. 9 to FIG. 11. FIG. 12 and FIG. 14 are plan views of mobile terminal apparatus 900, and FIG. 13 is a front view of mobile terminal apparatus 900. Here, FIG. 12 shows the open state of mobile terminal apparatus 900, and FIG. 14 shows the closed state of mobile terminal apparatus 900. Note that, in FIG. 12 to FIG. 14, tilt hinge members 104a and 104b, radio circuit 112 and electrically conductive connecting part 113 are provided in first housing 101, sliders 131a and 131b are provided in auxiliary member 103 and the other members are provided in second housing 102. Further, FIG. 12 and FIG. 14 do not show auxiliary member 103 for ease of explanation.

Second housing 102 has display section 124, guide rails 901a and 901b and extending element 902.

Extending element 902 electrically connects guide rail 901a and tilt hinge member 104a. In this case, extending element 902 electrically connects with tilt hinge member 104a by capacitive-coupling. Note that extending element 902 may electrically connect with tilt hinge member 104b instead of electrically connecting with tilt hinge member 104a. Further, extending element 902 may not only capacitive-couple with tilt hinge member 104a, but also may physically and electrically connect with tilt hinge member 104a.

As shown in FIG. 13, guide rails 901a and 901b have groove parts 1304a and 1304b formed with bottom surface parts 1301 and side surface parts 1302 and 1303. Further, guide rails 901a and 901b are provided in both end parts in the longitudinal direction (i.e. the left and right directions in FIG. 12) of rectangular second housing 102 from a plan view. Further, in second housing 102, guide rails 901a and 901b are provided along short sides 401 and 402 of rectangular second housing 102 from a plan view and in parallel to the lateral direction (i.e. the up and down directions in FIG. 12) of rectangular second housing 102 from a plan view. Groove parts 1304a and 1304b engage slidably with sliders 131a and 131b of auxiliary member 103. By this means, second housing 102 is allowed to slide in the lateral direction of rectangular second housing 102 from a plan view.

Display section 124 is, for example, an LCD, and displays an image of image data received at the antenna formed with electrically conductive connecting part 113, tilt hinge member 104a and guide rail 901a.

Next, the operation of mobile terminal apparatus 900 will be explained using FIG. 9 to FIG. 14.

In the closed state of mobile terminal apparatus 900, second housing 102 is slid in the right direction in FIG. 11 with respect to first housing 101. In this case, sliders 131a and 131b are guided by guide rails 901a and 901b, so that second housing 102 slides with respect to first housing 101. In this way, mobile terminal apparatus 900 is placed in the sliding state from the closed state.

Further, mobile terminal apparatus 900 is placed in the sliding state from the closed state, so that extending element 902 and second housing 102 slide together, placing extending element 902 and tilt hinge member 104a in the electrically contacting state from the electrically non-contacting state and placing guide rail 901a and tilt hinge member 104a in the electrically contacting state from the electrically non-contacting state.

By this means, mobile terminal apparatus 900 is placed in a state where tilt hinge member 104a and guide rail 901a function as an antenna, from the state where tilt hinge members 104a function alone as an antenna.

Next, in the sliding state of mobile terminal apparatus 900, second housing 102 is tilted up with respect to first housing 101. That is, in a state where second housing 102 couples with first housing 101 through tilt hinge members 104a and 104b, second housing 102 rotates in a direction to rise with respect to first housing 101, and is held in a state where second housing 102 rises at a predetermined angle by tilt hinge members 104a and 104b. By this means, mobile terminal apparatus 900 is placed in the open state.

In the open state, mobile terminal apparatus 900 maintains the state where guide rail 901a and tilt hinge member 104a electrically contact, so that guide rail 901a and tilt hinge member 104a function as an antenna. Thus, the antenna formed with guide rail 901a and tilt hinge member 104a receives radio waves of, for example, digital television broadcast, and display images of, for example, digital television broadcast on display section 124 provided in second housing 102.

To view, for example, digital television broadcast, in the open state of mobile terminal apparatus 900, second housing 102 rotates in the direction in which second housing 102 lies with respect to first housing 101 in the state where second housing 102 couples with first housing 101 through tilt hinge members 104a and 104b. By this means, mobile terminal apparaus 900 is placed in the sliding state.

Next, second housing 102 slides with respect to first housing 101 in a direction in which second housing 102 overlaps first housing 101. By this means, mobile terminal apparatus 900 is placed in the closed state.

Further, mobile terminal apparatus 900 is placed in the closed state from the sliding state, so that extending element 902 and second housing 102 slide together. By this means, extending element 902 slides in a direction to part from tilt hinge member 104a, such that extending element 902 and tilt hinge member 104a are placed in the electrically non-contacting state from the electrically contacting state and guide rail 901a and tilt hinge member 104a are placed in the electrically non-contacting state from the electrically contacting state.

By this means, mobile terminal apparatus 900 is placed in the state where tilt hinge member 104a functions alone as an antenna, from the state where guide rail 901a and tilt hinge member 104a function as an antenna.

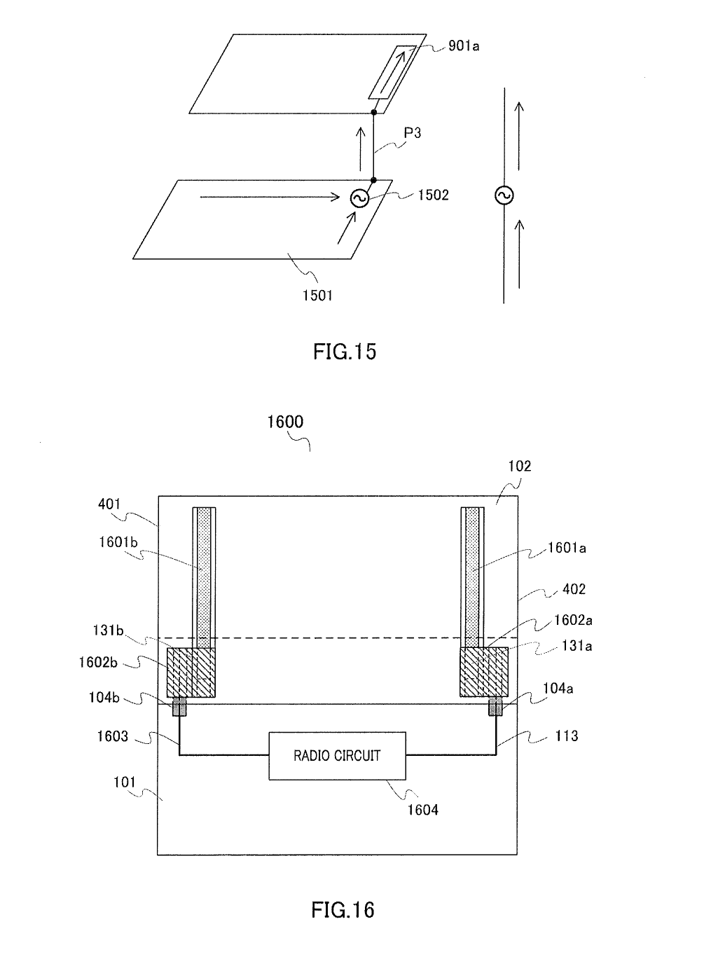

FIG. 15 shows a flow of current. FIG. 15 shows a flow of current in the sliding state and in the open state.

In the open state and the sliding state, ground part 1501, power feeding section 1502, electrically conductive path P3 and guide rail 901a provided in circuit substrate 111 function as an antenna, so that the flow of current becomes as shown in FIG. 15 and they function as a dipole antenna. Here, electrically conductive path P3 is formed with electrically conductive connecting part 113, tilt hinge member 104a and extending element 902

On the other hand, the same as in FIG. 8A applies to the closed state, and therefore explanation thereof will be omitted.

Thus, according to the present embodiment, in addition to the above advantage of Embodiment 1,by utilizing guide rails that guide the housing to slide, it is possible to reduce the number of parts and reduce the manufacturing cost. Further, according to the present embodiment, guide rails arranged at end parts of a second housing are made an antenna, so that it is possible to reduce the influence from, for example, the other electrically conductive members inside the mobile terminal apparatus, and prevent deterioration of antenna characteristics.

### Embodiment 3

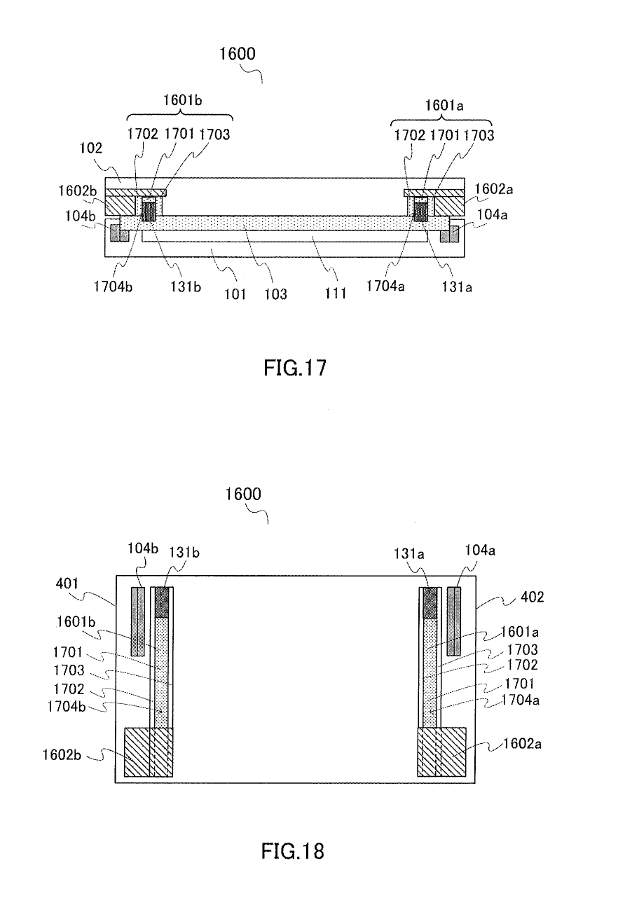

FIG. 16 to FIG. 18 are plan views of mobile terminal apparatus 1600 according to Embodiment 3 of the present invention. Further, FIG. 17 is a front view of mobile terminal apparatus 1600. Here, FIG. 16 shows the open state of mobile terminal apparatus 1600, and FIG. 18 shows the closed state of mobile terminal apparatus 1600.

Compared to mobile terminal apparatus 100 according to Embodiment 1 shown in FIG. 1, mobile terminal apparatus 1600 shown in FIG. 16 to FIG. 18 removes ground plate 121, adds electrically conductive connecting part 1603 and has guide rails 1601a and 1601b instead of guide rails 123a and 123b and has extending elements 1602a and 1602b instead of extending element 122. Note that, in FIG. 16 to FIG. 18, the same components as in FIG. 4 to FIG. 6 will be assigned the same reference numerals and will not be explained. Further, with the present embodiment, the side views of mobile terminal apparatus 1600 are the same as FIG. 9 to FIG. 11, and explanation thereof will be omitted. Note that, in FIG. 16 to FIG. 18, tilt hinge members 104a and 104b, radio circuit 1604 and electrically conductive connecting parts 113 and 1603 are provided in first housing 101, sliders 131a and 131b are provided in auxiliary member 103 and the other members are provided in second housing 102. Further, FIG. 16 and FIG. 18 do not show auxiliary member 103 for ease of explanation.

First housing 101 has circuit substrate 111, electrically conductive connecting parts 113 and 1603, and radio circuit 1604.

Radio circuit 1604 is mounted on circuit substrate 111. Further, circuit substrate 111 has an electrically conductive circuit pattern printed in the top surface and the back surface.

Radio circuit 1604 functions as a power feeding section which feeds power to tilt hinge members 104a through electrically conductive connecting part 113 and feeds power to tilt hinge member 104b through electrically conductive connecting part 1603. Further, radio circuit 1604 applies space diversity reception processing with respect to signals received at the antenna formed with electrically conductive connecting part 113, tilt hinge member 104a and guide rail 1601a and at the antenna formed with electrically conductive connecting part 1603, tilt hinge member 104b and guide rail 1601b. Here, “space diversity reception processing” means comparing the reception level of a signal received at the antenna formed with electrically conductive connecting part 113, tilt hinge member 104a and guide rail 1601a and the reception level of a signal received at the antenna formed with electrically conductive connecting part 1603, tilt hinge member 104b and guide rail 1601b, and selecting the signal received at the antenna having a greater reception level and performing reception processing.

Electrically conductive connecting part 113 electrically connects radio circuit 1604 and tilt hinge member 104a. Electrically conductive connecting part 113 may be formed with a member different from circuit substrate 111, or may be formed on circuit substrate 111 as a circuit pattern.

Electrically conductive connecting part 1603 electrically connects radio circuit 1604 and tilt hinge member 104b. Electrically conductive connecting part 1603 may be formed with a member different from circuit substrate 111, or may be formed on circuit substrate 111 as a circuit pattern.

Next, the configuration of second housing 102 will be explained using FIG. 16 to FIG. 18.

Second housing 102 has display section 124, guide rails 1601a and 1601b and extending elements 1602a and 1602b.

Extending element 1602a electrically connects guide rail 1601a and tilt hinge member 104a. In this case, extending element 1602a electrically connects with tilt hinge member 104a by capacitive-coupling. Note that extending element 1602a may not only capacitive-couple with tilt hinge member 104b but also may physically and electrically connect with tilt hinge member 104a.

Extending element 1602b electrically connects guide rail 1601b and tilt hinge member 104b. In this case, extending element 1602b electrically connects with tilt hinge member 104b by capacitive-coupling. Note that extending element 1602b may not only capacitive-couple with tilt hinge member 104b but also may physically and electrically connect with tilt hinge member 104b.

As shown in FIG. 13, guide rails 1601a and 1601b as electrically conductive members have groove parts 1704a and 1704b formed with bottom surface parts 1701 and side surface parts 1702 and 1703. Further, guide rails 1601a and 1601b are provided in both end parts in the longitudinal direction (i.e. the left and right directions in FIG. 16) of rectangular second housing 102 from a plan view. Further, in second housing 102, guide rails 1601a and 1601b are provided along short sides 401 and 402 of rectangular second housing 102 from a plan view and in parallel to the lateral direction (i.e. the up and down directions in FIG. 16) of rectangular second housing 102 from a plan view. Groove parts 1704a and 1704b engage slidably with sliders 131a and 131b of auxiliary member 103. By this means, second housing 102 is allowed to slide in the lateral direction of rectangular second housing 102 from a plan view.

Display section 124 is, for example, an LCD, and displays an image of image data received at the antenna formed with electrically conductive connecting part 113, tilt hinge member 104a and guide rail 1601a and at the antenna formed with electrically conductive connecting part 1603, tilt hinge member 104b and guide rail 1601b.

Next, the operation of mobile terminal apparatus 1600 will be explained using FIG. 16 to FIG. 18.

In the closed state of mobile terminal apparatus 1600, second housing 102 is slid in the right direction in FIG. 17 with respect to first housing 101. In this case, sliders 131a and 131b are guided by guide rails 1601a and 1601b, so that second housing 102 slides with respect to first housing 101. In this way, mobile terminal apparatus 1600 is placed in the sliding state from the closed state.

Further, mobile terminal apparatus 1600 is placed in the sliding state from the closed state, so that extending elements 1602a and 1602b and second housing 102 slide together, placing extending element 1602a and tilt hinge member 104a in the electrically contacting state from the electrically non-contacting state and placing extending element 1602b and tilt hinge member 104b in the electrically contacting state from the electrically non-contacting state.

By this means, mobile terminal apparatus 1600 is placed in a state where tilt hinge members 104a and guide rail 1601a, and tilt hinge members 104b and guide rail 1601b each function alone as an antenna, from the state where tilt hinge members 104a and 104b each function as an antenna.

Next, in the sliding state of mobile terminal apparatus 1600, second housing 102 is tilted up with respect to first housing 101. That is, in a state where second housing 102 couples with first housing 101 through tilt hinge members 104a and 104b, second housing 102 rotates in a direction to rise with respect to first housing 101, and is held in a state where second housing 102 rises at a predetermined angle. By this means, mobile terminal apparatus 1600 is placed in the open state.

In the open state, mobile terminal apparatus 1600 maintains the state where ground plate 1601a and tilt hinge member 104a electrically contact, and the state where ground plate 1601b and tilt hinge member 104b electrically contact. By this means, with mobile terminal apparatus 1600, the antenna formed with guide rail 1601a and tilt hinge member 104a and the antenna formed with guide rail 1601b and tilt hinge member 104b function as a space diversity antenna. Thus, the space diversity antenna formed with guide rail 1601a and tilt hinge members 104a, and guide rail 1601b and tilt hinge members 104b receive radio waves of, for example, digital television broadcast, and display images of, for example, digital television broadcast on display section 124 provided in second housing 102.

To view, for example, digital television broadcast, in the open state of mobile terminal apparatus 1600, second housing 102 rotates in the direction in which second housing 102 lies with respect to first housing 101 in the state where second housing 102 couples with first housing 101 through tilt hinge members 104a and 104b. By this means, mobile terminal apparaus 1600 is placed in the sliding state.

Next, second housing 102 slides with respect to first housing 101 in a direction in which second housing 102 overlaps first housing 101. By this means, mobile terminal apparatus 1600 is placed in the closed state.

Further, mobile terminal apparatus 1600 is placed in the closed state from the sliding state, so that extending element 1602a and 1602b and second housing 102 slide together. By this means, extending elements 1602a and 1602b slide in a direction to part from tilt hinge members 104a and 104b, such that extending elements 1602a and 1602b and tilt hinge members 104a and 104a are placed in the electrically non-contacting state from the electrically contacting state, and guide rail 1601a and tilt hinge member 104a and guide rail 1601b and tilt hinge member 104b are placed in the electrically non-contacting state from the electrically contacting state.

Further, mobile terminal apparatus 1600 is placed in the state where tilt hinge members 104a and 104b each function alone as a space diversity antenna, from the state where the antenna formed with guide rail 1601a and tilt hinge member 104a and the antenna formed with guide rail 1601b and tilt hinge member 104b function as a space diversity antenna.

Thus, according to the present embodiment, in addition to the above advantage of Embodiment 1,by utilizing guide rails that guide the housing to slide, it is possible to reduce the number of parts and reduce the manufacturing cost. Further, according to the present embodiment, by adopting, as an antenna, guide rails arranged at end parts of a second housing, it is possible to reduce the influence from, for example, the other electrically conductive members inside the mobile terminal apparatus and prevent deterioration of antenna characteristics. Further, according to the present embodiment, a plurality of guide rails and a plurality of tilt hinge members that are physically and electrically separated, each form a space diversity antenna, so that it is possible to improve received quality. Further, according to the present embodiment, guide rails are provided at both ends in the longitudinal direction of the rectangular of a rectangular second housing from a plan view, so that it is possible to increase the distance between antennas and reduce influences from each antenna compared to cases where guide rails are provided at both ends in the lateral direction of a rectangular.

Further, although, with the present embodiment, a plurality of guide rails and a plurality of tilt hinge members that are physically and electrically separated, each form a space diversity antenna, the present invention is not limited to this, and different antennas that receive radio waves of different communication schemes may be configured by making one antenna an antenna to receive digital television broadcast, and making the other antenna a Bluetooth (registered trademark) antenna or a GPS antenna. In this case, it is possible to support communication schemes of different frequencies by providing a matching circuit between a radio circuit and tilt hinge members.

### Embodiment 4

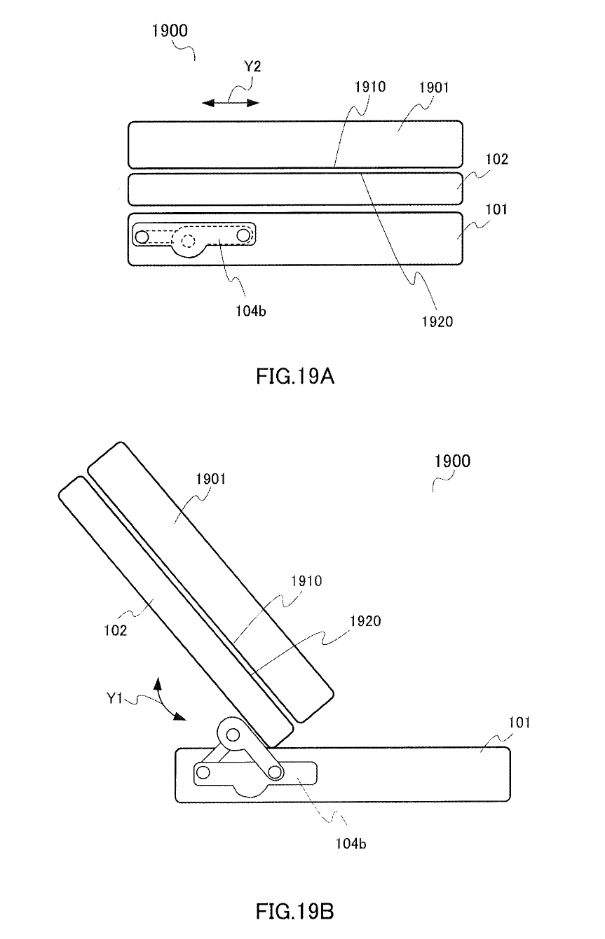

FIG. 19 is a side view of mobile terminal apparatus 1900 according to Embodiment 4 of the present invention. FIG. 19A shows the closed state of mobile terminal apparatus 1900, and FIG. 19B shows the open state of mobile terminal apparatus 1900.

Features of the present embodiment include providing third housing 1901 in addition to first housing 101 and second housing 102.

Third housing 1901 is allowed to slide with second housing 102 with respect to first housing 101, from the closed state to the sliding state or from the sliding state to the closed state. Further, third housing 1901 is attached to second housing 102 to be slidable with respect to second housing 102 on the front side and the depth side of FIG. 19. Further, third housing 1901 has a display section (not shown) that is exposed outside.

With second housing 102, an operating section (not shown) is exposed to outer surface part 1920 that faces outer surface part 1910 of the third housing.

Note that mobile terminal apparatus 1900 according to the present embodiment employs the same configuration and the same operation as one of the above mobile terminal apparatuses of Embodiment 1 to Embodiment 3, except for providing third housing 1901, and therefore will not be explained.

Thus, according to the present embodiment, the mobile terminal apparatus that adopts a structure in which three housings are layered, provide the same advantage as above Embodiment 1 to Embodiment 3.

Note that, although tilt hinge members are made an antenna with above Embodiment 1 to Embodiment 4, the present invention is not limited to this, and random hinge members other than tilt hinge members may be used as an antenna. Further, with above Embodiment 1 to Embodiment 4, although electrically conductive members that function as an antenna together with tilt hinge members are a ground plate or guide rails, the present invention is not limited to this, and it is possible to make random electrically conductive members function as an antenna together with tilt hinge members.

The disclosure of Japanese Patent Application No. 2008-106876, filed on Apr. 16, 2008, including the specification, drawings and abstract, is incorporated herein by reference in its entirety.

### INDUSTRIAL APPLICABILITY

The mobile terminal apparatus according to the present invention is suitable to view, for example, digital television broadcast.

1.-7. (canceled)

8. A mobile terminal apparatus, comprising:
a first housing that comprises a power feeding section;
a second housing that is attached to be slidable with respect to the first housing;
a hinge member that couples the first housing and the second housing rotatably; and
an electrically conductive guide member that is provided in the second housing, and that engages slidably with a slider provided in the first housing to guide the second housing to slide with respect to the first housing,
wherein the hinge member is fed power from the power feeding section, and function as an antenna together with the guide member when the hinge member electrically contacts the guide member accompanying the sliding.

9. The mobile terminal apparatus according to claim 8, comprising a plurality of hinge members,
wherein the hinge members each function as a plurality of antennas together with a plurality of guide members when the hinge members electrically contact each of the plurality of guide members accompanying the sliding of the second housing.

10. The mobile terminal apparatus according to claim 9
wherein the second housing is rectangular from a plan view, and comprises the guide members at both end parts in a longitudinal direction of the rectangular and slides in a lateral direction of the rectangular.

11. The mobile terminal apparatus according to claim 8
wherein the hinge member electrically contacts the guide member by capacitive-coupling with the guide member.

12. The mobile terminal apparatus according to claim 8
wherein the antenna can receive a radio wave of digital television broadcast.
